(19) United States
(12) Patent Application Publication
(10) Pub. No.: US 2006/0066122 A1
(43) Pub. Date: Mar. 30, 2006

(54) ATV Seat

(76) Inventor: Janice Wiseman, Milford, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/231,539

(22) Filed: Sep. 21, 2005

Related U.S. Application Data
(60) Provisional application No. 60/613,497, filed on Sep. 27, 2004.

(51) Int. Cl. B60N 2/02

(52) U.S. Cl. 296/65.01

(57) ABSTRACT

A seat for use with all terrain vehicles increases passenger comfort and safety by providing additional seating area for passengers and preventing dirt from striking or falling upon passengers. The seat may optionally be equipped with additional cargo storage baskets or attachment locations to carry additional cargo. The seat may be constructed with seat belts and a roll bar to further increase passenger safety.

### RELATED APPLICATIONS

The present application claims the benefit of U.S. Provisional Application Ser. No. 60/613,497, filed Sep. 27, 2004

### BACKGROUND OF THE INVENTION

1. Field of the Invention

The present invention relates to an ATV Seat. More particularly, the present invention relates to a removable seat which may be attached to a recreational vehicle, and which increases the comfort of passengers, provides areas of increased storage, and prevents dirt or debris which is thrown from the tires of the ATV from hitting passengers.

2. State of the Art

All terrain vehicles (ATV's) are becoming increasingly popular among outdoor enthusiasts. They are used for a variety of outdoor activities, such as camping, hunting, and pleasure riding. Additionally, they have many utilitarian uses, such as transporting goods and persons on a farm or ranch, plowing snow, or moving large items.

ATV's are advantageous for the above and other uses for a variety of reasons. ATV's are useful because they allow a person to pull or haul significantly more gear or baggage than a person could carry. When camping, a person can carry tents, sleeping gear, cooking equipment and food, etc., across a trail to the campsite in a few trips with an ATV, eliminating a larger number of difficult trips carrying these items by hand. Additionally, the ATV can carry items which are too heavy or large to reasonably be carried by hand.

ATV's are also useful for their speed. A person can safely travel on an ATV at speeds many times faster than a person can walk, saving considerable time in moving persons or items across distances.

ATV's are also useful as small sized work vehicles, allowing a farmer or rancher to quickly check fences, make repairs, etc. where a larger vehicle is not practical. The ATV can be used to carry or pull almost anything within the power capabilities of the vehicle. Additionally, many persons use ATV's around their home, for purposes such as gardening, landscaping, or plowing snow.

One drawback of available ATV's is the relative lack of cargo space. Primarily, they are designed for pleasure riding, and consist mainly of a driver and possibly passenger seat. A person must typically purchase and install an aftermarket cargo rack or tray to gain significant cargo carrying capability.

Additionally, ATV's are often less comfortable for a passenger, requiring the passenger to sit on a small, backless seat and hold the driver for support. Commonly, a passenger will find that after riding the ATV, their back is covered with mud, dirt, or dust which has been thrown up from the tires of the ATV, particularly the rear tires. The passenger safety is also compromised because the passenger is not supported by a seat back, and often lacks anything to hold on to other than the driver.

There is thus a need for improved functionality, comfort, and safety for ATV's. There is a need to provide passengers with a more comfortable and safe seat which does not subject them to the objects thrown by the tires. There is also a need for improved cargo carrying capacity on ATV's

### SUMMARY OF THE INVENTION

It is an object of the present invention to provide an improved ATV jump seat.

According to one aspect of the present invention, the jump seat provides a seat and backrest which are more comfortable than the seating provided for a passenger on a typical ATV.

According to another aspect of the present invention, the seat and backrest may be constructed to be wide enough to provide comfortable seating for two passengers, where an ATV will typically only allow a single passenger.

According to another aspect of the present invention, the seat may be provided with a seat belt or roll cage, and is safer than the original ATV passenger seating, if any. According to another aspect of the invention, the seat back and seat bottom reduce debris thrown from the tires from hitting the passengers.

According to yet another aspect of the present invention, the seat frame and cushions provide additional cargo space.

### BRIEF DESCRIPTION OF THE DRAWINGS

The present invention will now be discussed in reference to numbered drawings in which:

FIG. 1 shows a side view of a typical utility four wheeler;

FIG. 2 shows a rear view of a typical utility four wheeler with gear disposed thereon;

FIG. 3 shows a perspective view of a rear portion of a four wheeler with a jump seat according to the present invention;

FIG. 4 shows another perspective view of a jump seat according to the present invention;

FIG. 5 shows a side view of a typical sport four wheeler;

FIG. 6 shows a sport four wheeler with a jump seat attached according to the present invention;

FIG. 7 shows a rear view of a jump seat in accordance with the present invention; and

FIG. 8 shows a perspective view of another jump seat according to the present invention.

### DETAILED DESCRIPTION

The drawings will now be discussed in reference to the numerals provided therein so as to enable one skilled in the art to practice the present invention. The drawings and descriptions are exemplary of various aspects of the invention and are not intended to narrow the scope of the appended claims.

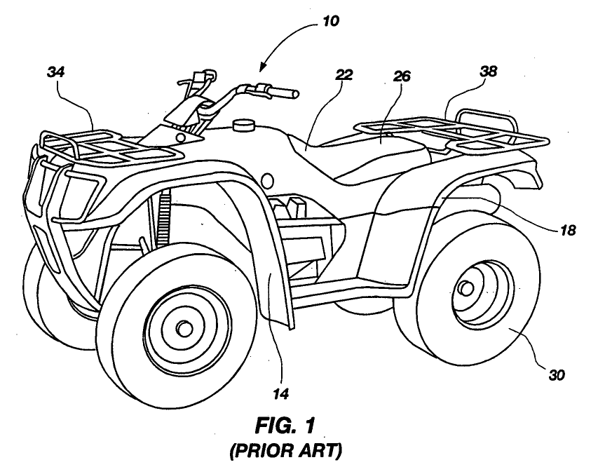

Referring now to FIG. 1, a typical four wheeler, generally indicated at 10, designed for utility purposes is shown. Although four wheelers are discussed in reference to the present invention, it will be appreciated that the principles of the present invention apply to a variety of ATV's and recreational vehicles and that the scope of this application is not limited solely to four wheelers.

The four wheeler 10 is typically constructed with front wheel wells 14 and rear wheel wells 18. The wheel wells are designed to prevent mud or dirt from hitting the driver of the four wheeler 10. Often, however, the wheel wells, and the rear wheel wells 18 in particular, are not sufficient to prevent dirt from being thrown on a passenger. This is especially true on dusty roads. The driver will sit in the forward part of the seat 22, and is protected from the dirt. A passenger is then obligated to sit in the rearward part of the seat 26, and is relatively unprotected from the dirt thrown from the rear tires 30. The rear tires 30 extend backwards to approximately the same position as the rear wheel wells 18, and thus dirt may be thrown vertically and strike the back of the passenger. Additionally, the air movement around the moving four wheeler 10 can cause the dirt and dust raised by the four wheeler to be blown onto a passenger.

A utility four wheeler 10 may be provided with storage racks 34, 38. Although useful, the storage racks on a four wheeler are often small and do not hold sufficient cargo. Additionally, when a passenger is riding on the four wheeler 10, the rear storage rack 38 may not be used, or may be only partially filled with cargo. Thus, little cargo space remains when a passenger is riding on the four wheeler 10.

Turning now to FIG. 2, a rear view of a typical utility four wheeler 10 is shown. The four wheeler is shown with cargo 42 attached to the rear storage rack 38. It is easily appreciated how a small amount of cargo 42 prevents a passenger from riding on the four wheeler by covering the rearward part (28, FIG. 1) of the seat.

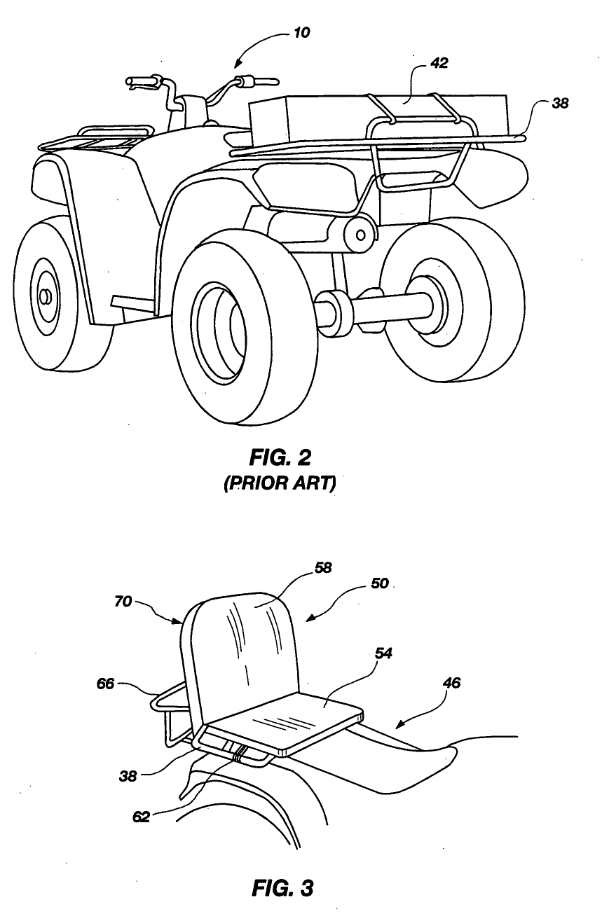

Turning now to FIG. 3, the rear portion of a four wheeler, indicated generally at 46, is shown. The four wheeler 46 has a jump seat, indicated generally at 50, made in accordance to aspects of the present invention attached. It will be appreciated that, while the invention is primarily described in the application as a jump seat with corresponding uses thereof, the invention is equally suitable as a cargo storage device, providing for increased ability to transport items with the four wheeler. Additionally, the jump seat provides for a comfortable seating location while the four wheeler or ATV is stopped, and provides increased protection from dust and dirt while only one person is riding the ATV. Those utilizing the present invention will appreciate that the use of a jump seat according to the present invention should be in conformance with applicable regulations and restrictions such as the ability of the ATV to safely carry the added weight of the jump seat and any additional cargo.

The jump seat 50 is made with a seat portion 54, and a back portion 58. The jump seat 50 may be constructed to attach to a rear storage rack 38 if the four wheeler 46 is so equipped. The seat portion 54 may be constructed with or without a rigid frame as desired. It will be appreciated that a frame may not be necessary as some ATV's 46 are equipped with a storage rack 38, but that a frame is often desirable to better control the shape of the jump seat 50 or to aid in securing the jump seat to an ATV. The seat portion 54 will typically be constructed with a pad of sufficient thickness to provide comfortable seating to a passenger. Additionally, the jump seat 50 may be covered with vinyl, nylon, or another covering which is sufficiently durable and resistant to the elements.

The back portion 58 may be constructed with a rigid frame, as no suitable frame is commonly available as part of the rear cargo rack 38. The frame, if used, may be constructed of tubular steel, although other materials and methods of construction are equally suitable. The back portion 58 will also typically be constructed with a pad so that the jump seat 50 is comfortable for a passenger, and is typically covered.

The back portion 58 and the seat portion 54 of the jump seat 50 may be constructed so that they are separate seat portions, or so that they are attached to each other. The jump seat 50 will typically be stronger if the two seat portions are connected together. Additionally, the seat portions 54 and back portion 58 may be attached together with a hinge. This allows the angle of the back portion 58 to be adjusted relative to the seat portion 54. This may also allow for additional storage capability, as the upper portion of the seat may be folded backwards or forwards when a passenger is not occupying the seat, providing additional cargo space.

If the seat portion 54 and back portion 58 of the seat are constructed with a hinge as discussed, a locking mechanism will be provided to prevent the seat from accidentally moving. The locking mechanism need be sufficiently strong to prevent the seat from collapsing under the weight of a passenger or a moderate amount of cargo. For example, the locking mechanism may include a series of aligning holes placed in overlapping plates formed in both the upper and lower seat portions through which a bolt may be placed to lock the angle of the back portion 58 relative to the seat portion 54.

The jump seat 50 may be attached to the four wheeler in a variety of ways. The jump seat may be held to the storage rack 38 with straps 62, such as nylon webbing, or alternatively, the seat may be bolted to the storage rack directly or with brackets. For vehicles without storage racks 38, the jump seat 50 may be constructed to bolt directly to the vehicle, either by using existing mounting holes or by forming new mounting holes, or the seat may be attached to the vehicle by a clamp or hold down strap.

The jump seat 50 is also shown with a storage container 66. The storage container 66 shown is made from tubular steel or other suitable materials and may typically be formed as an open basket. A storage container 66 may be sized so as to accommodate a cooler or other items. The storage container 66 is attached to the frame of the back portion 58. Many options are available for providing additional storage on the back side (indicated generally at 70) of the back portion 58. The back side 70 of the back portion 58 may be formed with a number of attachment brackets or attachment holes, allowing various items to be bolted or otherwise attached to the seat. Thus, a variety of different cargo storage containers 66 such as baskets or racks may be attached to the back side 70 of back portion 58. Additionally, the support frame of the upper seat portion may be left exposed, allowing attachment of various storage racks.

The back side 70 of the back portion 58 may also be provided with a number of exposed steel tubes or attachment loops whereby objects may be attached with nylon straps, rope, or the like. This is particularly advantageous where a number of differently sized items are carried. For example, where two individuals desire to go camping with the four wheeler, the jump seat 50 provides a comfortable seat for the passenger, and the camping gear, such as the tent, sleeping bags, food, etc., may be attached to the back side 70 of the back portion 58.

Accordingly, the jump seat 50 may be configured such that a very flexible storage arrangement exists, allowing the user to customize the storage capabilities according to their needs.

The jump seat 50 may be constructed of various widths, according to the needs of the passengers. A jump seat 50 which is wider is typically desirable to maximize passenger comfort. The jump seat 50 shown will increase passenger comfort by better supporting the passenger while the vehicle is accelerating, turning, bouncing, etc. as compared to the rearward part of the existing four wheeler seat.

It will also be appreciated that a wide jump seat 50, such as the one shown, will effectively block any mud or dirt which is thrown from the rear tires and prevent the dirt from hitting a passenger which is sitting in the jump seat. Additionally, the jump seat 50 is useful in preventing the dust clouds commonly formed when driving on dusty roads from covering the passenger with dust. The jump seat 50 is thus useful in making the passenger comfortable and in keeping the passenger clean.

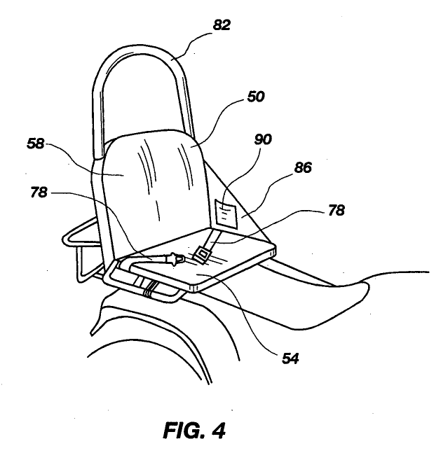

Turning now to FIG. 4, another jump seat 50, similar to that of FIG. 3, is shown. The jump seat 50 is equipped with additional features to add to the safety and comfort of the passengers. A seat belt 78 is shown, which may add significantly to the safety of the passengers. Often, individuals desire to take smaller children for a ride on a four wheeler, or otherwise transport the children on the four wheeler, but are hesitant to do so because the children may fall off of the vehicle. The jump seat 50 significantly adds to the safety of the children in providing a more stable and secure seat, and in providing a seat belt to prevent the children from being thrown from or falling off of the vehicle while it is moving.

The jump seat 50 may also be provided with an additional seat belt, allowing two children to safely ride as passengers. If the jump seat 50 is made approximately as wide as the rear fenders of the four wheeler, it will be sufficiently wide to safely and comfortably accommodate two child passengers, or one adult and one child passenger.

Additionally, the jump seat 50 may be provided with a roll bar 82. The roll bar 82 will typically be designed such that it extends sufficiently high to prevent injury to a passenger who is sitting on the vehicle. The roll bar 82 may also be sized according to the needs of particular individuals, such as children. The jump seat 50 may accordingly be designed to be particularly safe to use for transporting children on an ATV.

Additionally, the jump seat 50 may be provided with side webbing 86. The webbing 86 may be configured to more securely hold a passenger in the seat, or may be designed to reduce the passenger's exposure to the wind, dust, or other elements. Additionally, the webbing 86 may provide a convenient location for storage pockets 90. Storage pockets 90 which are placed in easy reach of the passenger provide access to snacks, water, or other conveniences for both the passenger and the driver.

The side webbing 86 may also be designed to be easily removable, allowing an ATV user to customize the jump seat 50 according to the present needs. The webbing 86 may be added for the comfort and convenience of a passenger, or may be removed where the jump seat 50 is used for carrying cargo. The webbing 86 may be attached by a variety of means which are sufficiently strong to prevent accidental removal of the webbing. Such means include, but are not limited to, zippers, nylon straps, rope lacing, bolts, etc.

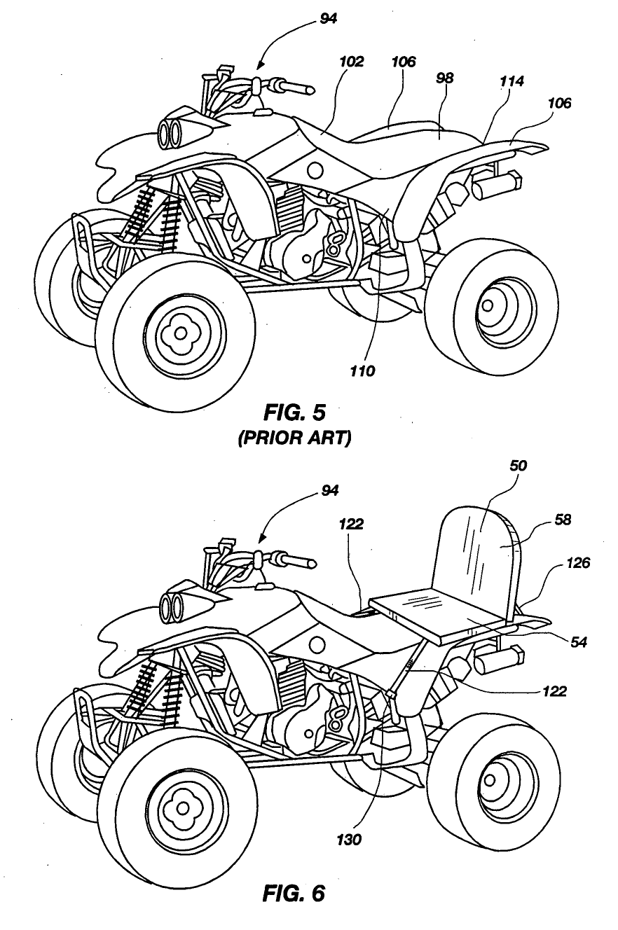

Turning now to FIG. 5, a four wheeler 94 is shown which is primarily designed for recreational or sport riding. Typically, such four wheelers are not equipped with cargo racks as is often the case with utilitarian four wheelers, and may also have a smaller location for a passenger, or may simply have no additional seating. Where an individual has a sport type four wheeler, it is especially advantageous to have a seat according to the present invention.

The four wheeler 94 has a small rearward portion 98 of the seat 102. Additionally, the four wheeler 94 has rear fenders 106, which may be used to provide support for a jump seat (not shown). A jump seat according to the present invention provides the additional passenger seating and cargo space which is lacking in the typical sport style four wheeler 94. The present invention thus allows an individual great flexibility in purchasing a four wheeler, as they may purchase a sport style four wheeler or ATV, and install a jump seat 50 when needed for carrying passengers or cargo.

The jump seat would thus typically be constructed to be readily removable, allowing an individual to create the additional storage and seating as needed, and leave the vehicle unencumbered when the additional space is not necessary.

The jump seat may be designed to bolt to the four wheeler 94, using existing mounting holes (not shown) if provided around the seat 102 or rear fender 106 area. If the four wheeler 94 is not equipped with any mounting holes, a user may drill holes through the fenders as necessary. Additionally, as many users will not desire to drill holes in their vehicle, the jump seat may be attached with nylon straps or the like. Suitable attachment points include the front of the fenders 110, the rear of the fenders 114, or the frame in these areas.

Turning now to FIG. 6, a sport style four wheeler, indicated generally at 94, is shown with a jump seat 50 according to the present invention. The jump seat 50 is attached to the four wheeler 94 with a pair of front straps 122, and a pair of rear straps 126. The straps 122, 126 may attach to the fenders or to the frame, and are accordingly provided with suitable brackets 130. The brackets 130 may be formed with a hole allowing the bracket to be bolted to a mounting point, or may be formed with a hook shaped portion allowing the bracket to attach to the fender or frame. If desired, the jump seat 50 may be designed to be as wide or slightly wider that the fenders of the four wheeler 94, and will thus aid in blocking dirt, mud, or rocks which are thrown up as the four wheeler moves from striking the passenger.

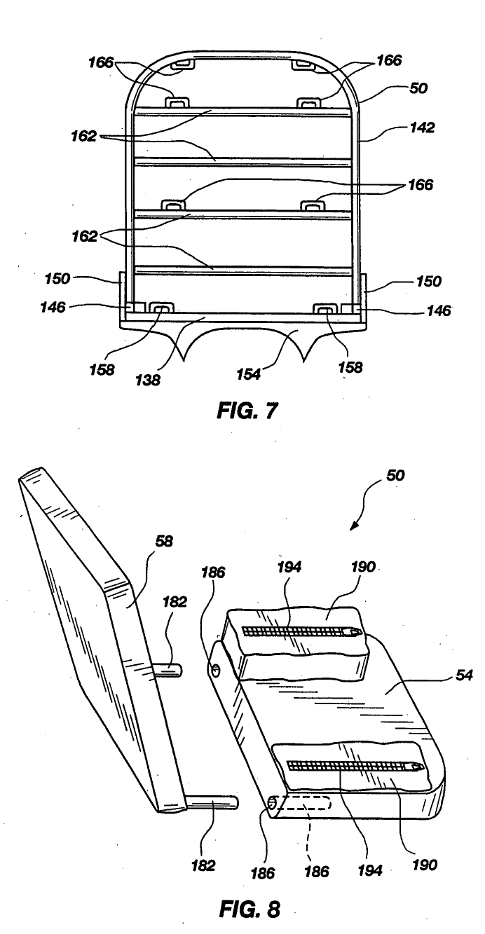

Turning now to FIG. 7, a rear view of a jump seat 50 according to the present invention is shown. The rigid structure of the jump seat 50 may typically consist of a lower frame 138, which supports the lower seat portion (not shown) and attaches the jump seat 50 to a four wheeler. The upper frame 142 is attached to the lower frame 138 with a hinge 146 which allows the back portion 58 to pivot relative to the seat portion 54. The hinge 146 is used in combination with a locking device 150 which, when locked, prevents rotation of the upper frame 142 relative to the lower frame 138. The locking device 150 may consist of a plate having a series of holes in a circular pattern which is attached to the lower frame 138 and a corresponding hole in the upper frame 142 through which a bolt or pin is passed to lock the upper frame 142 in position. The locking device may also consist of a toothed engagement piece, a piece of metal having a slot formed therein to limit the movement of the seat, or any other suitable locking means. Providing the jump seat 50 with a hinge 146 and locking device 150 also allows the jump seat to be folded down when necessary, such as when transporting the ATV on a trailer or when storing the ATV.

Although not necessary, the jump seat 50 is shown with a contoured lower piece 154 which is designed to fit the contours of the rear seat portion and wheel fenders of a four wheeler. The contoured lower piece 154 may be constructed of a plastic, foam, or other material which is sufficiently stiff to prevent excessive movement of the seat when mounted on the four wheeler. Additionally, the jump seat 50 is provided with mounting brackets 158 which are attached to the lower frame 138. The mounting brackets 158 may be used in combination with nylon straps or the like to secure the jump seat 50 to a four wheeler.

The upper frame 142 is shown constructed with a number of lateral frame pieces 162 which serve to support the back portion (not shown) as well as provide a convenient location to attach items using rope, straps, mounting brackets, or the like. Additionally, a number of mounting brackets 166 may be attached to the lateral frame pieces 162 to provide a convenient location to attach cargo. Additionally, the mounting brackets 166 may be used to bolt or otherwise attach a basket (66, FIG. 3) or other storage devices to the jump seat 50.

It will be appreciated that providing mounting brackets 166 on the back portion 58 allows a user to attach a variety of items to the ATV, such as a tent, sleeping bag, etc. A basket 66 may be attached to the seat as previously discussed to allow a user to carry tools or other items on the back of the seat. The jump seat 50 thus allows for expanded person and cargo carrying capacity, allowing an ATV to be used to carry both a passenger and desired equipment. Such a jump seat 50 makes the ATV more convenient for many recreational uses such as camping, or for uses such as field or maintenance work.

Turning now to FIG. 8, a perspective view of another jump seat, indicated generally at 50, is shown. The jump seat 50 includes an back portion 58 and a seat portion 54. The back portion 58 is formed with two protrusions 182 which fit into corresponding receptacles 186 formed in the seat portion 54. The protrusions 182 and receptacles 186 allow the back portion 58 to be removed from the seat portion 54 for storage, transportation, etc. Bolts, retaining pins, etc., may be used to hold the protrusions 182 into the receptacles 186, preventing accidental removal of the back portion 58.

The seat portion 54 may be formed with pockets 190 which are placed on the upper surface of the seat portion. The pockets 190 are typically formed with a zipper 194 or other suitable closure element. The pockets 190 may be collapsible so as to be minimally obtrusive when empty. The jump seat 50 may be attached to the ATV in the manners discussed above, including mounting brackets or straps which attach to the ATV frame, rack, or body, or to mounting holes formed in the ATV.

According to another aspect of the invention, the jump seats 50 as discussed above may include removable covers which allow a person to replace a dirty or damaged cover or to select a desired color or style of cover. For such an arrangement, the jump seat 50 will typically include a frame and padding which substantially define the shape and structure of the seat and a cover which fits over the frame and padding. The cover may be formed in two separate pieces, one for the seat portion 54 and one for the back portion 58. The cover may include the pockets 190 or storage compartments as discussed, and may have openings to allow access to attachment brackets formed on the frame.

There is thus disclosed an ATV jump seat in accordance with the present invention. It will be appreciated that numerous modifications may be made to the present invention without departing from the scope of the invention. The preceding description is intended to be exemplary of aspects of the invention, and not limiting of the scope of the invention.

What is claimed is:

1. An ATV jump seat comprising:
a seat portion;
a back portion; and
wherein the jump seat is configured for removable attachment to an all terrain vehicle.

2. The jump seat of claim 1, further comprising a hinge to allow pivoting of the back portion relative to the seat portion.

3. The jump seat of claim 2, further comprising a locking mechanism for selectively locking the position of the back portion relative to the seat portion.

4. The jump seat of claim 1, further comprising a frame.

5. The jump seat of claim 4, wherein the frame further comprises attachment points configured for removably attaching cargo to the jump seat.

6. The jump seat of claim 4, wherein the frame comprises an upper frame associated with the back portion and a lower frame associated with the seat portion.

7. The jump seat of claim 4, wherein the frame further comprises a storage container.

8. The jump seat of claim 7, wherein the storage container is removably attached to the frame.

9. The jump seat of claim 1, wherein the seat portion is approximately as wide as the rear wheel fenders of the all terrain vehicle.

10. The jump seat of claim 1, further comprising means for removably attaching the jump seat to an all terrain vehicle.

11. The jump seat of claim 10, wherein the attachment means is selected from the group consisting of: bolts, nuts, screws, mounting brackets, rope, straps, or cables.

12. The jump seat of claim 1, further comprising at least one seat belt.

13. The jump seat of claim 1, further comprising webbing extending between the sides of the seat portion and the corresponding sides of the back portion.

14. The jump seat of claim 10, wherein the seat further comprises pockets disposed on the webbing.

15. The jump seat of claim 1, further comprising storage pockets formed on the upper surface of the seat portion.

16. The jump seat of claim 2, wherein the back portion may be rotated towards the rear of the vehicle until horizontal and used for carrying cargo.

17. The jump seat of claim 1, wherein the seat inhibits dust or dirt raised by the movement of the vehicle from striking the occupant of the seat.

18. The jump seat of claim 1, further comprising a roll bar.

19. The jump seat of claim 1, wherein the back portion is removable from the seat portion.

20. A method for facilitating riding an all terrain vehicle, wherein the method comprises:
selecting a jump seat comprising a seat portion and a back portion; and
removably mounting the jump seat on an all terrain vehicle adjacent the rear wheel fenders so as to provide a seat for a passenger.

21. An all terrain vehicle comprising:
an all terrain vehicle comprising a plurality of wheels, a seat, and a rear fender covering at least two of the plurality of wheels; and
a jump seat disposed adjacent the rear fender, the jump seat having a seat portion and a back portion.

22. The vehicle of claim 21, wherein the back portion is pivotably attached to the seat portion.

23. The vehicle of claim 21, wherein the back portion is removably attached to the seat portion.

24. The vehicle of claim 21, wherein the jump seat is removably attached to the all terrain vehicle.

25. The vehicle of claim 21, wherein the jump seat further comprises a storage container.

26. The vehicle of claim 21, wherein the jump seat further comprises storage pockets.

27. The vehicle of claim 21, wherein the jump seat further comprises a seat belt.

28. The vehicle of claim 21, wherein the jump seat further comprises a roll bar.
